(19) United States
(12) Patent Application Publication
(10) Pub. No.: US 2009/0247011 A1
(43) Pub. Date: Oct. 1, 2009

(54) CONNECTOR ASSEMBLY HAVING PRIMARY AND SECONDARY LOCKING FEATURES

(76) Inventors: John Mark Myer, Millersville, PA (US); John Wesley Hall, Harrisburg, PA (US); Hurley Chester Moll, Hershey, PA (US)

Correspondence Address: Lisa Burgin Vaccarelli;Tyco Technology Resources, Suite 140, 4550 New Linden Hill Road, Wilmington, DE, 19808, US

(21) Appl. No.: 12/057,166

(22) Filed: Mar. 27, 2008

(51) Int. Cl. H01R 13/422

(52) U.S. Cl. 439/595

(57) ABSTRACT

A connector assembly includes a housing having a cavity defined by at least one wall. The cavity extends between a mating end and a loading end. The housing has a terminal latch associated with the cavity, and the at least one wall has a projection extending into the cavity. A terminal is loaded into the cavity through the loading end and is held within the cavity by the terminal latch. The terminal includes body having an opening, wherein the projection extends at least partially into the opening to secure the terminal within the cavity.

### BACKGROUND OF THE INVENTION

The subject matter herein relates generally to connector assemblies, and more particularly to connector assemblies having terminal position assurance devices and secondary locking features.

In various applications of electrical connectors, devices are utilized to lock terminals in place and to assure that the terminals are in proper position within the electrical connector. One such field is in the automotive field where the application typically requires a locking system for locking the terminals in place, as well as a terminal position assurance (TPA) device which assures that the terminals are in proper position longitudinally within the respective cavities. Typically, the locking system and TPA device cooperate to prevent mating of a corresponding electrical connector, where some of the lines are open due to one or more terminals not being fully loaded.

Currently, certain electrical connectors are provided with housings having cavities extending therethrough for receiving terminals. The cavities are provided with resilient locking latches integrally molded with the housing for locking terminals inserted therein. In order to further secure the terminals within the housing, at least some known electrical connectors provide the TPA device that is moveable against the locking latch to prevent the locking latch from outwardly biasing. In other words, the locking latches are blocked into their latching position. It is known to provide the TPA device pre-assembled to the housing in a pre-assembly position that allows insertion of the terminals into the connector cavities. The TPA device can then be moved to a fully locked position whereby the terminals are locked in the cavities.

However, due to the harsh environment in which the electrical connectors may be used, such as in an automotive application, the locking latch may become damaged or break. In such circumstances, the terminal may vibrate at least partially out of the cavity or may be inadvertently removed from the cavity, breaking the connection with the mating connector.

Hence, a need remains for an electrical connector that includes a secondary locking feature to secure the terminal within the cavity in the advent of the primary locking latch being damaged or broken. Additionally, it would be desirable to provide an electrical connector that does not rely on movable or fragile components for securing the terminal within the cavity.

### BRIEF DESCRIPTION OF THE INVENTION

In one embodiment, a connector assembly is provided that includes a housing having a cavity defined by at least one wall. The cavity extends between a mating end and a loading end. The housing has a terminal latch associated with the cavity, and the at least one wall has a projection extending into the cavity. A terminal is loaded into the cavity through the loading end and is held within the cavity by the terminal latch. The terminal includes a body having an opening, wherein the projection extends at least partially into the opening to secure the terminal within the cavity.

Optionally, the terminal body may have a plurality of walls with an open mating end for receiving a mating terminal, wherein one of the walls includes the opening for receiving the projection. The cavity may be sized to allow the terminal to be moved over the projection until the projection is aligned with the opening. The terminal body may include a mating end for mating with a mating terminal and a rear end, wherein the terminal latch engages the rear end to lock the terminal within the cavity. Optionally, a blocking surface may be provided on the opposite side of the cavity as the protrusion, wherein the terminal engages the blocking surface to resist movement of the terminal sufficient to release the protrusion from the opening. Optionally, a terminal position assurance device may be movably coupled to the housing. The terminal position assurance device is movable between a released position and a blocking position, wherein the terminal position assurance device is movable to the blocking position only when the terminal latch is holding the terminal. The terminal position assurance device may block the terminal from disengaging from the protrusion when in the blocking position.

In another embodiment, a connector assembly is provided including a housing having a cavity defined by at least one wall having a projection extending into the cavity. The housing has a terminal latch associated with the cavity, wherein the terminal latch is movable between an unlatched and a latched position. The connector assembly also includes a terminal including a body having an opening, wherein the terminal is received within the cavity and is movable therein between an unloaded position and a loaded position. When the terminal is in the loaded position, the projection extends at least partially into the opening to secure the terminal within the cavity and the terminal latch is movable to the latched position engaging the terminal and securing the terminal within the cavity.

Optionally, the body may have a mating end and a rear end, wherein the terminal latch engages the rear end in the latched position to resist unloading of the terminal. A web portion of the contact may be defined between the opening and the mating end, wherein, as the terminal is loaded into the cavity, the web portion engages the projection. Optionally, the at least one wall defines a base wall, and the projection extends from the base wall. When the terminal is in the loaded position, the terminal rests against the base wall, and when the terminal is in the unloaded position, at least a portion of the terminal is unseated from the base wall to clear the projection. Optionally, the projection may engage an edge of the body defining the opening to resist movement of the terminal in a removal direction.

### BRIEF DESCRIPTION OF THE DRAWINGS

FIG. 1 is an exploded view of a connector assembly having a terminal position assurance device and a terminal mountable therein in accordance with an exemplary embodiment.

FIG. 2 is a cross-sectional view of the connector assembly during a first stage of assembly.

FIG. 3 is a cross-sectional view of the connector assembly during a second stage of assembly.

FIG. 4 is a cross-sectional view of the connector assembly during a third stage of assembly.

FIG. 5 is a cross-sectional view of the connector assembly during a fourth stage of assembly.

### DETAILED DESCRIPTION OF THE INVENTION

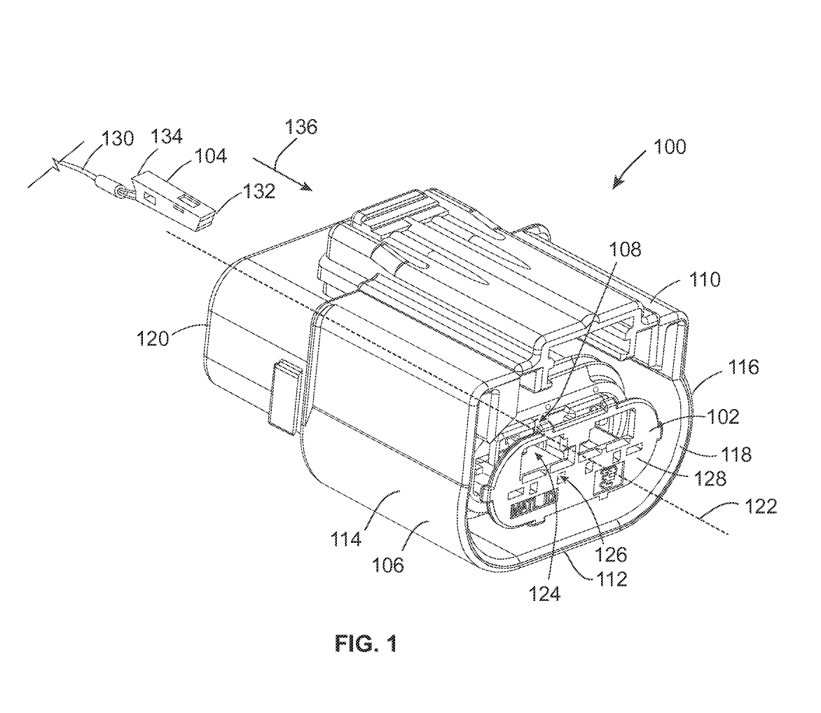

FIG. 1 is an exploded view of a connector assembly 100 having a terminal position assurance (TPA) device 102 and at least one terminal 104 mountable therein. The connector assembly 100 may be used in an application, such as in an automotive vehicle system, that involves the interconnection of electrical or fiber optic conductors within the system. The connector assembly 100 represents a robust, low cost, compact design. Furthermore, the configuration and arrangement of the connector assembly 100 enables use of simplified design and manufacturing processes, increasing turnover and lowering cost without adversely impacting quality and reliability.

The connector assembly 100 includes a housing 106 having a plurality of cavities 108 for receiving the individual terminals 104 that mate with a corresponding mating contacts of a mating connector (not shown). The housing 106 includes a top end 110, a bottom end 112, opposed right and left sides 114, 116, a front or mating end 118 and a rear or loading end 120. The housing 106 may have any size and shape depending on the particular application and the corresponding mating connector. Additionally, while four cavities 108 are illustrated in FIG. 1 that receive four terminals 104, any number of cavities 108 and terminals 104 may be provided depending on the particular application. The housing 106 has a longitudinal axis 122 extending from the front end 118 to the loading end 120. The cavities 108 extend along the longitudinal axis 122.

The TPA device 102 is movably coupled to the mating end 118 of the housing 106. The TPA device 102 includes a plurality of cavity openings 124 that provide access to the cavities 108 of the housing 106. The mating contacts of the mating connector are inserted into the cavities 108 through the cavity openings 124 in the TPA device 102. The TPA device 102 includes a plurality of channels 126 extending therethrough for receiving an extraction tool (not shown). The channels 126 correspond to, and are aligned with, the cavities 108. The TPA device 102 also includes a generally planar faceplate 128 at the front end of the TPA device 102. The cavity openings 124 and the channels 126 extend through the faceplate 128.

The terminals 104 are terminated to ends of wires 130. The terminals 104 and wires 130 form a wire harness that interconnect another component or device with the connector assembly 100. The terminals 104 include a mating end 132 and a wire terminating end 134. The wires 130 are terminated to the wire terminating end 134, such as by a crimp connection. Alternative terminating methods and processes may be used to terminate the wires 130 to the terminals 104, such as soldering, insulation displacement connections, and the like. The terminals 104 are loaded into the individual cavities 108 through the loading end 120 of the housing 106 in a loading direction 136 that is generally parallel to the longitudinal axis 122.

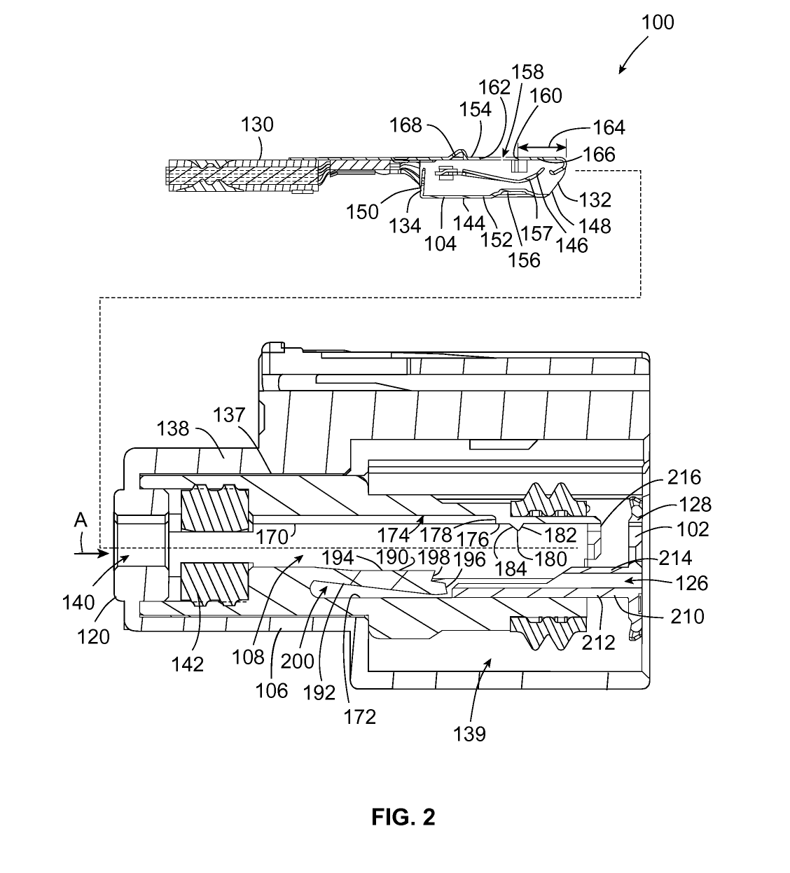

FIG. 2 is a cross-sectional view of the connector assembly 100 during a first stage of assembly. The housing 106 is illustrated with the cavity 108 extending longitudinally therethrough. The housing 106 includes an inner housing portion 137 and an outer housing portion 138. A chamber 139 is formed between the inner and outer housing portions 137, 138 that receives a portion of the mating connector during mating. Optionally, the inner housing portion 137 may be inserted into the outer housing portion 138 during assembly. The terminal 104 is loaded through an opening 140 at the loading end 120 of the housing 106. Optionally, a seal 142 may be provided proximate to the opening 140 to seal the cavity 108.

The terminal 104 includes a body 144 extending between the mating end 132 and the wire terminating end 134. The body 144 is generally box-shaped and includes a plurality of walls that surround a contact 146. For example, the body 144 may include a front wall 148 at the mating end 132, a rear wall 150 at the wire terminating end 134, a bottom wall 152 and a top wall 154. In an exemplary embodiment, the walls of the body and the contact 146 are integrally formed, such as from a metal blank that is stamped and formed into the terminal 104. The contact 146 may be a cantilevered beam that is spaced apart from a recessed section 156 of the bottom wall 152. The mating contact (not shown) is received between a mating interface 157 of the contact 146 and the recessed section 156. Optionally, the mating contact flexes the contact 146 such that the contact 146 biases against the mating contact to ensure electrical connection between the mating contact and at least one of the contact 146 and the recessed section 156.

In an exemplary embodiment, an opening 158 is provided in the top wall 154 of the terminal 104. The opening 158 defines front and rear edges 160, 162 on opposite sides of the opening 158. The front edge 160 is positioned a distance 164 from the front wall 148. The portion of the top wall 154 between the front wall 148 and the front edge 160 defines a web portion 166. The top wall 154 is generally planar and includes a rib 168 rearward of the opening 158. A front of the rib 168 defines a stop, limiting the forward motion of the terminal 104 during the loading process.

The cavity 108 is defined by a top wall 170 and a bottom wall 172. The top wall 170 includes a slot 174 formed therein proximate the rear of the cavity 108 and a ledge 176 surrounding the slot 174. A shoulder 178 is defined at the front of the slot 174. The shoulder 178 defines a forward stop for the rib 168 to limit the forward loading of the terminal 104 during the loading process. The top wall 170 includes a projection 180 extending into the cavity 108. In the illustrated embodiment, the projection 180 extends from the ledge 176 generally forward of the slot 174. The projection 180 includes a front ramp surface 182 and a rear ramp surface 184. The front ramp surface 182 is approximately vertical. As will be described in further detail below, the projection 180 defines a stop for removing the terminal 104 from the cavity 108. The projection 180 has a height measured from the surface of the ledge 176 to a tip.

The housing 106 includes a terminal latch 190 provided within the cavity 108. The latch 190 is positioned proximate the bottom wall 172 of the cavity 108. The latch 190 includes a lower surface 192 and an upper surface 194. In an exemplary embodiment, the latch 190 is cantilevered from a wall of the cavity 108. Alternatively, the latch 190 may be coupled to the housing 106 and/or the cavity walls. The latch 190 extends to a latching end 196 at the forward end of the latch 190. A notch 198 is formed at the latching end 196. In an exemplary embodiment, the lower surface 192 of the latch 190 is spaced apart from the bottom wall 172 of the cavity 108 forming a flex space 200 therebetween. The flex space 200 allows the latch 190 to flex downward as the terminal 104 is being loaded into the cavity 108, such as is illustrated in FIG. 2.

The TPA device 102 is coupled to the housing 106 such that a portion of the TPA device 102 is received in the cavity 108. The TPA device 102 includes an arm 210 that extends rearward from the faceplate 128. The channel 126 extends through the arm 210. The arm 210 includes an outer end 212 and an inner end 214. The outer end 212 is longer than the inner end 214 such that the outer end 212 extends further from the faceplate 128 than the inner end 214.

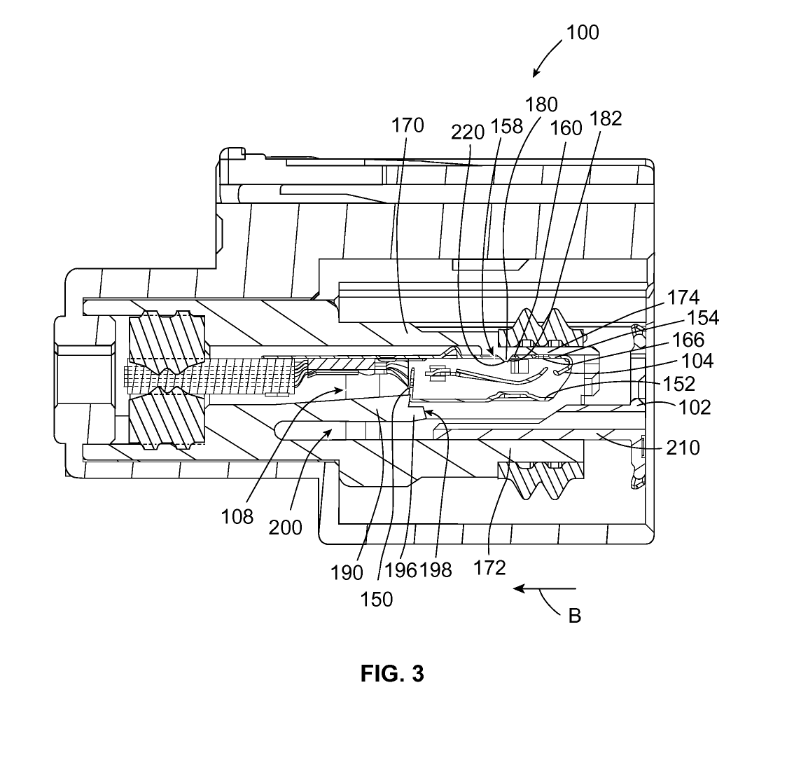

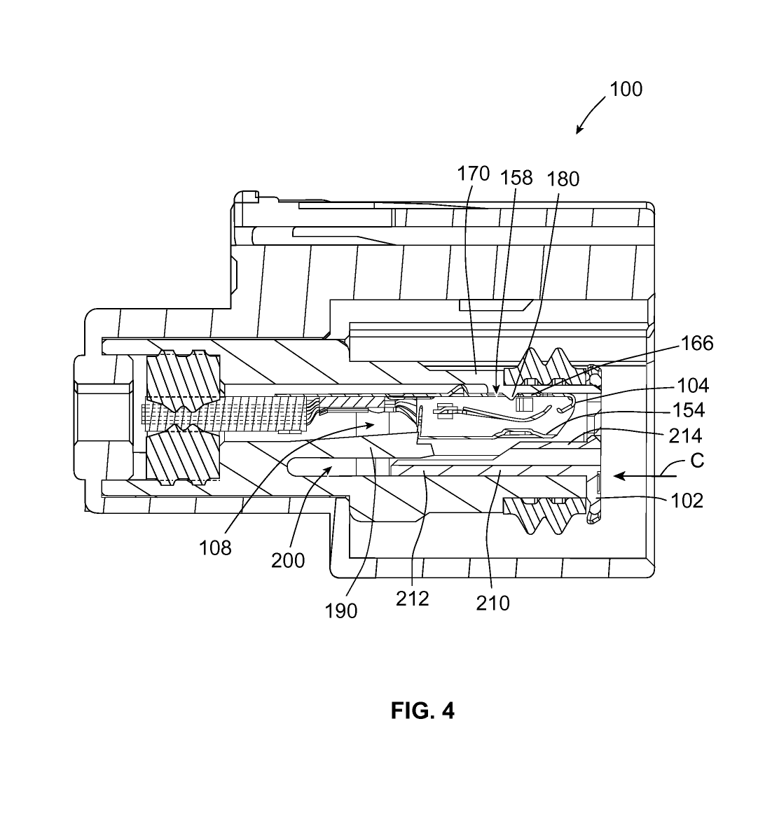

As noted above, FIG. 2 illustrates the connector assembly 100 during a first stage of assembly. The first stage of assembly involves loading the terminal 104 into position within the cavity 108. The terminal 104 is transferred from an unloaded position to a loaded position (shown in FIG. 3), in the direction of arrow A. The terminal 104 is transferred between the positions by pushing or otherwise inserting the terminal 104 and/or the associated wire 130 into the cavity 108 through the opening 140 at the loading end 120 of the housing 106. During the first stage(s) of assembly, the TPA device 102 is in a released or open position, in which the faceplate 128 is spaced apart from a front wall 216 of the inner housing portion 137. The TPA device 102 is movable between the released or open position and a blocking or closed position, such as that illustrated in FIG. 4.

As the terminal 104 is loaded into the cavity 108, the web portion 166 at the front wall 148 initially engages the projection 180 and rides up the rear ramp surface 184 such that the top wall 154 of the terminal 104 is slightly unseated from, or otherwise spaced apart from, the top wall 170 of the cavity 108. A gap is provided between the terminal 104 and the top wall 170 of the cavity 108 as the terminal is loaded into the cavity 108. As the terminal 104 is loaded, the projection 180 rides generally rearwardly along the web portion 166. In an exemplary embodiment, when the terminal 104 is in the unseated position, the bottom wall 152 of the terminal 104 is substantially, axially aligned with the inner end 214 of the arm 210 of the TPA device 102. The TPA device 102 is thus restricted from closing, as the inner end 214 would engage the terminal 104 if the TPA device 102 were closed or pushed inward.

During loading of the terminal 104 into the cavity 108, the latch 190 is flexed outward to an unlatched position. For example, as the bottom wall 152 of the terminal 104 engages the upper surface 194 of the latch 190, the latch 190 is hinged about the cavity wall into the flex space 200. In an exemplary embodiment, when the latch 190 is pushed into the flex space 200, the latching end 196 of the latch 190 is substantially, axially aligned with the outer end 212 of the arm 210 of the TPA device 102. The TPA device 102 is thus restricted from closing, as the outer end 212 would engage the latch 190 if the TPA device 102 were closed or pushed inward. In the unlatched position, the notch 198 of the latch 190 is non-engaging or non-latching with the rear wall 150 of the terminal 104, as compared to when the latch 190 is in a latched position, such as that illustrated in FIG. 3.

FIG. 3 is a cross-sectional view of the connector assembly 100 during a second stage of assembly. In the second stage of assembly, the terminal 104 is in the loaded position, the latch 190 is in the latched position and the TPA device 102 remains in the released or open position.

As the terminal 104 reaches the loaded position from the unloaded position, the projection 180 is aligned with the opening 158. For example, once the terminal 104 is moved forward to the point that the front edge 160 is aligned with or just beyond the projection 180, the projection 180 is received within the opening 158. As the front edge 160 slides down the front ramp surface 182, the terminal 104 is eventually seated against the ledge 176 of the cavity top wall 170.

In the loaded position, the top wall 154 is vertically aligned with the projection 180 such that a tip 220 of the projection 180 is at least partially received within the terminal 104. The front ramp surface 182 blocks the terminal 104 from moving axially within the cavity 108. For example, in order for the terminal 104 to move from the loaded position back to the unloaded position, the terminal 104 would have to be moved, such as by being pushed or otherwise moved downward, such that the web portion 166 would clear the tip 220 of the projection 180. Notably, a predetermined amount of clearance is provided between the bottom wall 152 and the arm 210 of the TPA device 102 to allow the terminal 104 to be moved downward such that the terminal can be unloaded from the cavity 108. The clearance is provided when the TPA device 102 is in the released or open position, such as that illustrated in FIG. 3. However, as described in further detail below, when the TPA device 102 is moved to the closed or blocking position, the arm 210 blocks the terminal 104 from being moved enough to clear the projection 180.

FIG. 3 illustrates the latch 190 in a latched position. In the latched position, the latching end 196 engages the rear wall 150 of the terminal 104. For example, the notch 198 engages the rear wall 150 and the bottom wall 152 of the terminal 104. In an exemplary embodiment, the latch 190 is flexed into the flex space 200 during the loading of the terminal 104, but once the terminal 104 is loaded to a certain depth, the rear wall 150 of the terminal 104 clears the latching end 196 and the latch 190 is clear to move to the latched position in which the latch 190 is generally axially oriented within the cavity 108. In the latched position, at least a portion of the latch 190 is positioned rearward of the terminal 104 and blocks rearward movement of the terminal 104 in an unloading direction, such as in the direction of arrow B. In the latched position, the flex space 200 is generally open and the latch 190 is positioned away from the bottom wall 172 of the cavity 108.

FIG. 4 is a cross-sectional view of the connector assembly 100 during a third stage of assembly. In the third stage of assembly, the terminal 104 is in the loaded position, the latch 190 is in the latched position and the TPA device 102 has been moved from the released or open position illustrated in FIG. 3 to a blocking or closed position. The TPA device 102 is moved to the blocking position by transferring, such as by pushing, the TPA device 102 in a rearward direction, shown by the arrow C.

In the blocking position, the arm 210 of the TPA device 102 blocks the latch 190 from moving radially outward. For example, the outer end 212 is at least partially received in the flex space 200 generally radially outward of the latch 190. The latch 190 is blocked from flexing outward to a point where the terminal 104 may be moved in an unloading direction. In other words, the latch 190 engages the terminal 104 if the terminal 104 is pulled in the rearward or unloading direction. The latch 190 thus operates as a primary locking feature to lock the terminal 104 within the cavity 108. Additionally, as described above, the TPA device 102 is restricted from moving to the blocking position unless the latch 190 is in the latched position as the latch 190 closes access to the flex space 200 when in the unlatched position, such as that shown in FIG. 2. Having the TPA device 102 in the blocking position thus assures the position of the latch 190 in the latched position.

In the blocking position, the arm 210 of the TPA device 102 defines a blocking surface and blocks the terminal 104 from moving away from the top wall 170 of the cavity 108. For example, the inner end 214 is aligned vertically below the bottom wall 154 of the terminal 104. The terminal 104 is restricted from moving vertically downward to a point where the opening 158 clears the projection 180. In other words, the web portion 166 engages the projection 180 if the terminal 104 is pulled in the rearward or unloading direction. The projection 180 thus operates as a secondary locking feature to lock the terminal 104 within the cavity 108 and is capable of operating even if the latch 190 is otherwise damaged or broken. Additionally, as described above, the TPA device 102 is restricted from moving to the blocking position unless the terminal 104 is in the loaded position as the terminal 104 blocks rearward movement of the TPA device 102 when in the unloaded and unseated position. Having the TPA device 102 in the blocking position thus assures the position of the terminal 104 in the loaded position.

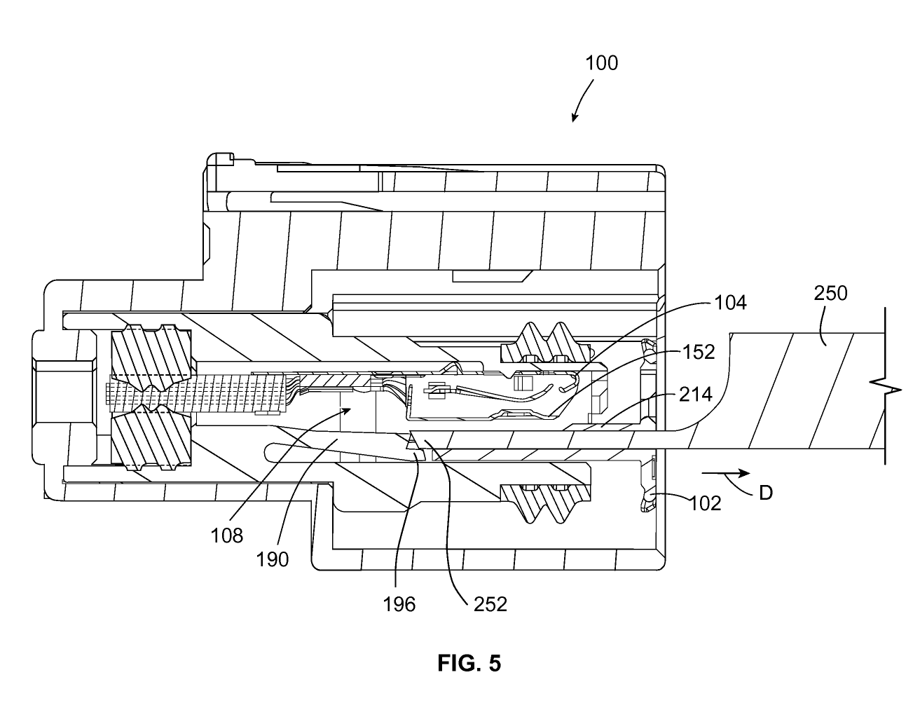

FIG. 5 is a cross-sectional view of the connector assembly 100 during a fourth stage of assembly. In the fourth stage of assembly, the terminal 104 is in the loaded position and the TPA device 102 has been moved from the blocking position to the released or open position. The TPA device 102 is moved to the released position by transferring, such as by pulling, the TPA device 102 in a forward direction, shown by the arrow D.

FIG. 5 also illustrates an extraction tool 250 inserted into the channel 126 extending through the arm 210. The tool 250 includes a tip 252 that engages the latching end 196 of the latch 190. The tool 250 is configured to force the latch 190 to an outwardly flexed position. In the outwardly flexed position, the latch 190 is unlatched and does not block the terminal 104 from rearward movement within the cavity 108.

With the TPA device 102 in the open or released position, the inner end 214 of the arm 210 is no longer aligned with the bottom wall 152 of the terminal 104. The terminal 104 has clearance between the bottom wall 152 and the tool 250 to move to an unseated position such that the projection 180 clears the opening 158. The projection 180 no longer blocks the terminal 104 from rearward movement and the terminal 104 may be moved to an unloaded position and ultimately removed from the cavity 108.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure.

What is claimed is:

1. A connector assembly comprising:
a housing having a cavity defined by at least one wall, the cavity extending between a mating end and a loading end, the housing having a terminal latch associated with the cavity, the at least one wall having a projection extending into the cavity, the projection being fixed in position relative to the cavity; and
a terminal loaded into the cavity through the loading end, the terminal being held within the cavity by the terminal latch, the terminal including a body having an opening, wherein the projection extends at least partially into the opening to secure the terminal within the cavity.

2. The connector assembly of claim 1, wherein the terminal body has a plurality of walls with an open mating end for receiving a mating terminal, wherein one of the walls includes the opening for receiving the projection.

3. The connector assembly of claim 1, wherein the cavity is sized to allow the terminal to be moved generally perpendicular to a loading direction of the terminal into the cavity to pass over the projection until the projection is aligned with the opening.

4. The connector assembly of claim 1, wherein the terminal body includes a mating end for mating with a mating terminal and a wire terminating end, the terminal latch engages the wire terminating end to lock the terminal within the cavity.

5. The connector assembly of claim 1, wherein a blocking surface is provided on the opposite side of the cavity as the projection, the terminal engages the blocking surface to resist movement of the terminal sufficient to release the projection from the opening.

6. The connector assembly of claim 1, further comprising a terminal position assurance device movably coupled to the housing, the terminal position assurance device having a blocking surface engaging the terminal generally opposite the projection to hold the terminal within the cavity.

7. The connector assembly of claim 1, further comprising a terminal position assurance device movable between a released position and a blocking position, the terminal position assurance device being movable to the blocking position only when the terminal latch is holding the terminal.

8. The connector assembly of claim 1, further comprising a terminal position assurance device movable between a released position and a blocking position, the terminal position assurance device blocking the terminal from disengaging from the projection when in the blocking position.

9. The connector assembly of claim 1, wherein the terminal latch defines a primary securing mechanism for holding the terminal within the cavity and the projection defines a secondary securing mechanism for securing the terminal within the cavity.

10. A connector assembly comprising:
a housing having a cavity defined by at least one wall having a projection extending into the cavity, the housing having a terminal latch associated with the cavity, wherein the terminal latch is movable between an unlatched and a latched position;
a terminal including a body having an opening, the terminal being received within the cavity and movable therein between an unloaded position and a loaded position, wherein, when the terminal is in the loaded position, the projection extends at least partially into the opening to secure the terminal within the cavity and the terminal latch is movable to the latched position to engage the terminal and secure the terminal within the cavity; and
a terminal position assurance device movably coupled to the housing, the terminal position assurance device having a blocking surface engaging the terminal when the terminal is in the loaded position to hold the terminal within the cavity.

11. The connector assembly of claim 10, wherein the body has a mating end and a rear end, the terminal latch engages the rear end in the latched position to resist unloading of the terminal.

12. The connector assembly of claim 10, wherein the body has a mating end and a rear end, a web portion is defined between the opening and the mating end, as the terminal is loaded into the cavity, the web portion engages the projection.

13. The connector assembly of claim 10, wherein the at least one wall defines a base wall, the projection extends from the base wall, when the terminal is in the loaded position, the terminal rests against the base wall, and when the terminal is transitioned from the loaded position to the unloaded position, at least a portion of the terminal is unseated from the base wall to clear the projection.

14. The connector assembly of claim 10, wherein the projection engages an edge of the body defining the opening to resist movement of the terminal in a removal direction.

15. The connector assembly of claim 10, wherein the terminal position assurance device is movable between a released position and a blocking position, with the terminal position assurance device being movable to the blocking position only when the terminal latch is holding the terminal, the blocking surface of the terminal position assurance device engaging the terminal when the terminal position assurance device is in the blocking position.

16. The connector assembly of claim 10, wherein the terminal position assurance device is movable between a released position and a blocking position, the terminal position assurance device blocking the terminal from moving a significant amount in a direction away from the projection when in the blocking position.

17. The connector assembly of claim 10, wherein the terminal position assurance device is movable between a released position and a blocking position, the blocking surface is substantially aligned with the projection when in the blocking position to block the terminal from releasing from the projection.

18. The connector assembly of claim 10, wherein the terminal position assurance device is movable between a released position and a blocking position, wherein when the terminal position assurance device is in the blocking position, an arm of the terminal position assurance device blocks the terminal latch from moving to the unlatched position.

19. The connector assembly of claim 10, wherein the terminal position assurance device is movable between a released position and a blocking position, wherein the terminal position assurance device includes a base wall having the blocking surface and an opening therethrough, wherein the opening is aligned with the terminal when the terminal position assurance device is in the released position and the base wall is aligned with the terminal when the terminal position assurance device is in the blocking position.

20. The connector assembly of claim 10, wherein the terminal position assurance device has an arm with a channel therethrough configured to receive an extraction tool, the terminal position assurance device being movable between a released position and a blocking position, when in the blocking position, the arm blocks the terminal latch from moving to the unlatched position, when in the released position, the extraction tool is configured to be inserted through the channel to release the latch to the unlatched position.
